(19) United States
(12) Patent Application Publication
(10) Pub. No.: US 2010/0089768 A1
(43) Pub. Date: Apr. 15, 2010

(54) Method for the electrochemical removal of a metal coating from a component

(76) Inventors: Jens Dahl Jensen, Berlin (DE); Ursus Krüger, Berlin (DE); Daniel Körtvelyessy, Berlin (DE); Ralph Reiche, Berlin (DE); Gabriele Winkler, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/308,723

(22) PCT Filed: Mar. 22, 2007
(86) PCT No.: PCT/EP2007/052723

§ 371 Date: Nov. 5, 2009

(30) Foreign Application Priority Data
Jun. 23, 2006 (EP) 06013037.4

(51) Int. Cl. B23H 5/06; C25F 3/02

(52) U.S. Cl. 205/662; 205/640; 205/674

(57) ABSTRACT

The invention relates to a method for the electrochemical removal of a metal coating from a component. According to said method, the component is immersed in an electrolyte solution and a current is passed through the component and a secondary electrode that is in contact with the electrolyte. The current is pulsed with a routine that has a duty cycle >10 to <90%, two current densities between 5 mA/cm² to 1000 mA/cm² and a frequency of 5 Hz to 1000 Hz.

### CROSS REFERENCE TO RELATED APPLICATIONS

This application is the US National Stage of International Application No. PCT/EP2007/052723, filed Mar. 22, 2007 and claims the benefit thereof. The International Application claims the benefits of European application No. 06013037.4 filed Jun. 23, 2006, both of the applications are incorporated by reference herein in their entirety.

### FIELD OF INVENTION

The invention relates to a method for the electrochemical removal of a metal coating from a component, in which the component is immersed in an electrolyte solution and a current is passed through the component and a secondary electrode, which is in contact with the electrolyte. The invention also relates to a method the electrochemical removal of a metal coating from a turbine blade.

### BACKGROUND OF THE INVENTION

Many components, which are exposed to high temperatures and corrosive conditions, are nowadays sometimes provided with multilayer protective coatings. This applies inter alia to components of gas turbines such as turbine blades, which are used in corrosive environments at temperatures in excess of 1000° C. Owing to the extreme loading, however, the coatings suffer wear and need to be refurbished at regular intervals. To this end, it is necessary first to remove the old damaged protective layers fully from the component, without thereby damaging the component itself. This procedure is part of the refurbishment process for turbine blades.

Protective coating systems for turbine blades are often designed in at least two layers, an adhesion layer which in many cases has a composition of the MCrAlX type being applied as the first layer directly on the component. On the surface of the adhesion layer there is a thermal barrier layer, for example based on ceramic, as the second layer. In order to be able to recoat a corresponding turbine blade in the scope of refurbishment, the upper ceramic thermal barrier layer is initially removed mechanically in a first step, for instance with the aid of sandblasting. In a further step, the metal adhesion layer is then stripped from the surface of the component. This may be done by using electrochemical methods, the turbine blade being immersed in an electrolyte solution and a suitable voltage being applied to the turbine blade and a secondary electrode, which is likewise arranged in the electrolyte solution.

DE 102 59 365 A1, for example, describes a device and a method for removing metal coatings from the surface of a component with the aid of an electrochemical process by using a pulsed current.

In the method known in the prior art, however, various problems arise. On the one hand, damage to the base material of the turbine blade may readily occur when using currents which are too strong, and on the other hand it is likewise possible that contamination incurred in the course of the operating time of the turbine blade, for example in the form of complex crystalline compounds, may not be removed fully, which makes recoating difficult or even impossible.

### SUMMARY OF INVENTION

It is therefore an object of the present invention to provide a method for the electrochemical removal of a metal coating, in which on the one hand rapid and complete layer stripping takes place, including crystalline contamination, but on the other hand damage to the base material of the component does not occur.

This object is achieved in that the current is pulsed with a routine which has a duty cycle of from >0% to <100%, in particular from 20% to 80%, two current densities of between 5 mA/cm² and 1000 mA/cm², preferably between 10 mA/cm² and 300 mA/cm², and a frequency of from 5 Hz to 1000 Hz, preferably from 25 Hz to 300 Hz.

The pulsed current thus alternately has an upper current density and a lower current density, and therefore does not decrease to zero. The time for which the current has the upper current density within a pulse sequence is referred to as the pulse duration t, and the time taken for the current to execute both current densities within a pulse sequence is referred to as the period duration T. The duty cycle is in turn the ratio of the pulse duration and the period duration t/T.

It has been found that by using a pulsed current, which is defined by the parameters mentioned above, on the one hand rapid and complete layer stripping of the metal coating is achieved, and on the other hand the damage to the component is avoided.

According to one embodiment of the invention, the duty cycle may be from 25 to 75%, preferably from 50% to 75%. The current densities may lie between 50 mA/cm² and 250 mA/cm², preferably between 100 mA/cm² and 200 mA/cm², and particularly preferably between 150 mA/cm² and 200 mA/cm². It has also been found that the frequency should lie in the range of between 50 Hz and 275 Hz, in particular between 150 Hz and 275 Hz.

In particular for the removal of metal coatings from turbine blades, the following current routines have been found to be advantageous: duty cycle 50%, current densities 100 mA/cm² and 150 mA/cm², and frequency 150 Hz; duty cycle 75%, current densities 100 mA/cm² and 150 mA/cm², and frequency 250 Hz; duty cycle 75%, current densities 150 mA/cm² and 200 mA/cm², and frequency 50 Hz; and duty cycle 50%, current densities 150 mA/cm² and 200 mA/cm², and frequency 250 Hz.

According to another embodiment, the electrolyte solution may contain or consist of an inorganic acid or an organic acid or an organic base or an inorganic base or mixtures of inorganic and organic acids and/or bases.

HCl is for example suitable as the acid, a concentration of less than 20% by weight, particularly less than 10% by weight and in particular less than 6% by weight in the electrolyte solution being advantageous.

It has also been found that the effective protection from unintended attack on the base material of the component can be achieved when the electrolyte solution contains an alkanolamine compound, or a salt containing this compound, as an inhibitor. Triethanolamine or one of its salts has been found to be a particularly suitable inhibitor. The protection may furthermore be increased when the electrolyte solution also contains further inhibitors such as carboxylic acids and/or aldehyde compounds and/or unsaturated alcohols.

At least one mechanical cleaning step by sandblasting may be provided in the method, which may for example be carried out immediately after the electrochemical stripping step in order to remove any residues of the coating which still adhere. It has been found advantageous for an insoluble MCrAlX coating mass per unit area of the component in the range of from 30 mg/cm² to 160 mg/cm², to be removed by the sandblasting. In this case, rapid layer removal takes place without causing damage to the component.

According to another embodiment, a further electrochemical stripping step with a direct current may be provided in the cleaning method.

As an alternative, a further electrochemical stripping step may also be carried out with a further pulsed current.

Advantageously the duty cycle of the further pulsed current may be higher than the duty cycle of the first pulsed current for the first stripping step. In particular, it may be at least 20% higher.

The further pulsed current may have a duty cycle of 50-99%, two current strengths of between 0.1 mA/cm² and 30 mA/cm², and a frequency of from 10⁻² to 100 Hz. The duty cycle of the further pulsed current may be 75-99%, particularly preferably 95-99%. The two current strengths of the further pulsed current may lie between 0.5 mA/cm² and 20 mA/cm², and preferably between 1 mA/cm² and 16 mA/cm². The frequency of the further pulsed current may be between 10⁻² and 1 Hz, and preferably between 10⁻² and 10⁻¹ Hz.

Also, the further electrochemical stripping step may be carried out for a time of from 1 to 60 minutes, preferably for a time of from 5 to 20 minutes. According to a particularly preferred embodiment, the additional pulsed current may have a duty cycle of 99%, two current strengths of between 1 mA/cm² and 16 mA/cm², and a frequency of 10⁻² Hz, and the further electrochemical stripping step may in particular be carried out with this current for 8 minutes.

If the further electrochemical stripping step is carried out directly after the sandblasting described above, then extremely small residues of the metal coating which still remain on the component can thereby be removed. Inadvertent damage to the component is then advantageously prevented owing to the low aggressivity of the method step.

Sandblasting may be carried out again after this method step.

Tests have shown that the method according to the invention is suitable in particular for components of gas turbines, such as turbine blades. These often have an MCrAlX layer as the metal coating, where M is selected from the group Fe, Co and/or Ni, and X is selected from the group Y, La or rare earths. It has been found that these layers can be removed rapidly and completely by the method according to the invention.

Another aspect of the invention provides a method for removing a metal coating from a turbine blade.

According to one embodiment of this aspect of the invention, regions lying inside the turbine blade are covered. In particular, internally aluminized regions may thus be protected from damage. Wax may in particular be used for the covering, since this can readily be removed without leaving residues by burning it out.

It is likewise possible to cover the blade root of the turbine blade with a cap before the blasting. In this way, the blade root is protected from impact of blasting material. After the blasting, the cap is removed again so that it does not interfere with the further processing.

Corundum may be used as the blasting material. This may have a grain size of mesh 46 or less.

The first blasting step may be carried out with a blasting pressure of at most 5 bar and all the further blasting steps may be carried out with a blasting pressure of at most 3 bar. This will ensure that a sufficiently large proportion of the metal coating is removed, without the turbine blade itself being damaged.

Outer regions of the turbine blade may be covered, in order to prevent damage. Wax in particular is suitable for this, since this can readily be removed without leaving residues by burning it out.

According to another embodiment of this aspect of the invention, the turbine blade in the region of the coating is immersed in an electrolyte solution in the main stripping step and in the secondary stripping step. A current is then passed through the turbine blade connected as an anode and a secondary electrode, which is in contact with the electrolyte solution.

HCl may be used as the electrolyte solution. The concentration of HCl may be less than 20% by weight, particularly less than 10% by weight and in particular less than 6% by weight.

The main stripping step and the secondary stripping step may be carried out with a temperature of the electrolyte solution in the range of 15-25° C., particularly in the range of 18-22° C.

It is likewise possible to monitor the metal ion concentration in the electrolyte solution, in order to replace the electrolyte solution when there is too high a concentration. This applies in particular for an iron ion concentration >100 ppm.

The main electrochemical stripping step may be carried out by a method as claimed in the claims. An advantage here is that parts of the metal coating can be removed rapidly and without damaging the turbine blade.

As an alternative, a direct current may be passed through the turbine blade and the secondary electrode during the main electrochemical stripping step.

The duration of the electrochemical stripping step may be at most 60 minutes.

According to another embodiment of this aspect of the invention, a pulsed current is passed through the turbine blade and the secondary electrode during the secondary electrochemical stripping step. As an alternative, a direct current may also be used.

The secondary electrochemical stripping step may be carried out for a time of at most 30 minutes.

The turbine blade may be heat-tinted at a temperature in the range of 500-700° C., in particular 550-650° C., in order to check whether the coating has been fully removed. It may be heat-tinted for 20-40 minutes, in particular for 30 minutes.

Any remaining residues of the metal coating may be removed by grinding. Furthermore, the turbine blade may be labeled after removal of the coating.

### BRIEF DESCRIPTION OF THE DRAWINGS

The invention will be explained in more detail below with the aid of an exemplary embodiment with reference to the appended drawings, in which:

FIG. 1 shows a device for carrying out the method according to the invention in a schematic representation,

FIG. 2 shows a diagram which illustrates a first current pulsed with a routine,

FIG. 3 shows a diagram which illustrates a second current pulsed with a routine,

FIG. 4 shows a flow chart of a method according to the invention for removing a metal coating from a turbine blade,

FIG. 5 shows a gas turbine,

FIG. 6 shows a turbine blade, and

FIG. 7 shows a combustion chamber.

### DETAILED DESCRIPTION OF INVENTION

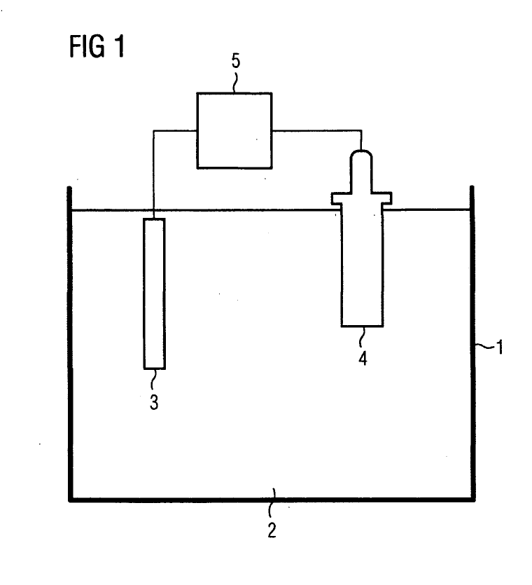

FIG. 1 first shows a device for carrying out the method according to the invention.

The device consists of an electrolyte container 1 which is filled with an electrolyte solution, this preferably being an aqueous HCl solution with a strength of from 4% by weight to 6% by weight, which also contains for example triethanolamine as an inhibitor. A secondary electrode 3 and a turbine blade 4, which has an MCrAlX coating on its surface, is immersed in the electrolyte solution 2. The secondary electrode 3 and the component 4 are connected electrically conductively to a generator 5.

In order to free the turbine blade 4 from coatings (coating mass), for instance in the scope of refurbishment, any thermal barrier layer applied on the MCrAlX layer is removed mechanically in a first step. This may preferably be done by sandblasting or water spraying or dry ice blasting.

The turbine blade 4 may subsequently also be activity-blasted, i.e. subjected to a mechanical treatment of the surface, in particular by sandblasting.

The turbine blade 4, now provided only with the MCrAlX layer, is immersed in the electrolyte solution 2 until the MCrAlX layer is fully in contact with the electrolyte solution 2 and connected electrically conductively to the generator 5.

The generator 5 subsequently passes a pulsed current through the secondary electrode 3 and the turbine blade 4 during the electrochemical removal of the MCrAlX layer.

The pulsed current is characterized by a duty cycle of from >10% to <90%, two current densities of between 5 mA/cm² and 1000 mA/cm², and a frequency of from 5 Hz to 1000 Hz.

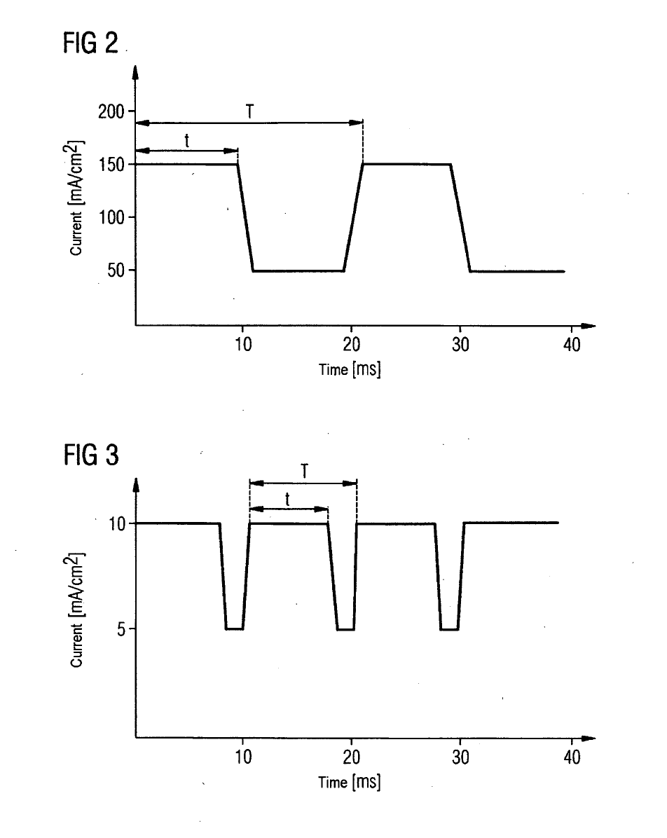

FIG. 2 shows a diagram of such a pulsed current. In the diagram, t denotes the pulse duration i.e. the time for which the current has the upper current density, and T denotes the period duration which the current takes to execute the upper current density once and the lower current density once. The duration of the pulses generated in this way is determined by the frequency 1/T=f. The ratio of the pulse duration and the period duration gives the duty cycle.

The pulsed current shown in FIG. 2 has an upper current density of 150 mA/cm² and a lower current density of 50 mA/cm², and its duty cycle is 50%.

After the MCrAlX layer has been stripped almost completely from the turbine blade 4 by the electrochemical stripping step, the current is turned off and the turbine blade 4 is removed from the electrolyte solution 2.

In order to remove residues of the coating which may possibly still remain on the turbine blade 4, a mechanical cleaning step by sandblasting is preferably carried out first. Insoluble MCrAlX mass per unit area of the turbine blade 4 in the range of from 30 mg/cm² to 160 mg/cm² is thereby removed, and it has been found advantageous for the amount to be from 30 mg/cm² to 70 mg/cm², in particular 34 mg/cm² to 51 mg/cm².

The pulsed electrochemical stripping method may likewise be interrupted in order to sandblast the turbine blade 4.

Preferably, the pulsed electrochemical stripping method is not interrupted. Cleaning may also be carried out after removal from the electrolyte solution 2, particularly in a liquid, in particular in water.

Tables 1 and 2 show feature combinations which have been studied for their suitability and respectively show good results.

TABLE 1

| | |
|---|---|
| | Design parameter |
| Feature | matrix |

| combinations | A | B | C | D |
|---|---|---|---|---|
| 1 | 1 | 1 | 1 | 1 |
| 2 | 1 | 2 | 2 | 2 |
| 3 | 1 | 3 | 3 | 3 |
| 4 | 2 | 1 | 2 | 3 |
| 5 | 2 | 2 | 3 | 1 |
| 6 | 2 | 3 | 1 | 2 |
| 7 | 3 | 1 | 3 | 2 |
| 8 | 3 | 2 | 1 | 3 |
| 9 | 3 | 3 | 2 | 1 |

TABLE 2

| | Setting levels | | |
|---|---|---|---|
| Factors | 1 | 2 | 3 |
| A current density | 150 | 200 | 200 |
| (mA/cm²) | 100 | 100 | 150 |
| B frequency (Hz) | 50 | 150 | 250 |
| C duty cycle (%) | 25 | 50 | 75 |
| D sandblasting (mg/cm²) | 34 | 51 | 68 |

It has been found that a high removal rate for coatings can be achieved in particular with feature combinations 2, 3, 5, 7, 8 and 9.

Following the first sandblasting and/or after the electrochemical stripping step, a further electrochemical stripping step may also be carried out with direct current.

In principle the arrangement shown in FIG. 1 may be used for this, if the generator 5 is also adapted to deliver a corresponding direct current to the secondary electrode 3 and the turbine blade 4. It has been found in particular that a direct current of about 16 mA/cm² provides good results, since residues of the coating which still remain on the surface of the turbine blade 4 can thereby be removed gently without attacking the turbine blade 4 itself in its base material. In particular, 8 minutes are suitable as a process time.

As an alternative, a further electrochemical stripping step may also be carried out with a pulsed current. This pulsed current may for example have a duty cycle of 99%, two current strengths of between 1 mA/cm² and 16 mA/cm², and a frequency of 10⁻² Hz.

FIG. 3 shows such a pulsed current which has a lower current density of 5 mA/cm², an upper current density of 10 mA/cm² and a duty cycle of 80%.

It has also been found that 8 minutes, in particular, are suitable as a process time for the further electrochemical stripping step with the pulsed current.

Owing to this further electrochemical stripping step with the pulsed current, residues still remaining on the surface of the turbine blade 4 are removed gently without attacking the turbine blade 4 itself in its base material.

Lastly, two concluding method steps may also be carried out, namely further sandblasting and heat tint.

The method according to the invention may therefore preferably involve the following steps:
1. Removal of the TBC layer
2. Activity blasting, in particular sandblasting
3. First electrochemical stripping with a pulsed current
4. First sandblasting
5. Second electrochemical stripping with a direct current (for example about 16 mA/cm² for about 8 minutes)
6. Second sandblasting
7. Heat tint

or
1. Removal of the TBC layer
2. Activity blasting, in particular sandblasting
3. First electrochemical stripping with a pulsed current
4. First sandblasting
5. Second electrochemical stripping with a further pulsed current (for example with a duty cycle of 99%, two current strengths of between 1 mA/cm² and 16 mA/cm², and a frequency of 10⁻² Hz for about 8 minutes)
6. Second sandblasting
7. Heat tint

or
1. Electrochemical stripping with a pulsed current

or
1. Activity blasting, in particular sandblasting
2. Electrochemical stripping with a pulsed current

or
1. First electrochemical stripping with a pulsed current
2. Second electrochemical stripping with a direct current (for example about 16 mA/cm² for about 8 minutes)

or
1. First electrochemical stripping with a pulsed current
2. Second electrochemical stripping with a further pulsed current (for example with a duty cycle of 99%, two current strengths of between 1 mA/cm² and 16 mA/cm², and a frequency of 10⁻² Hz for about 8 minutes)

or
1. Activity blasting, in particular sandblasting
2. First electrochemical stripping with a pulsed current
3. Second electrochemical stripping with a direct current (for example about 16 mA/cm² for about 8 minutes)

or
1. Activity blasting, in particular sandblasting
2. First electrochemical stripping with a pulsed current
3. Second electrochemical stripping with a further pulsed current (for example with a duty cycle of 99%, two current strengths of between 1 mA/cm² and 16 mA/cm², and a frequency of 10⁻² Hz for about 8 minutes)

or
1. First electrochemical stripping with a pulsed current
2. Sandblasting
3. Second electrochemical stripping with a direct current (for example about 16 mA/cm² for about 8 minutes)

or
1. First electrochemical stripping with a pulsed current
2. Sandblasting
3. Second electrochemical stripping with a further pulsed current (for example with a duty cycle of 99%, two current strengths of between 1 mA/cm² and 16 mA/cm², and a frequency of 10⁻² Hz for about 8 minutes)

or
1. Activity blasting, in particular sandblasting
2. First electrochemical stripping with a pulsed current
3. Sandblasting
4. Second electrochemical stripping with a direct current (for example about 16 mA/cm² for about 8 minutes)

or
1. Activity blasting, in particular sandblasting
2. First electrochemical stripping with a pulsed current
3. Sandblasting
4. Second electrochemical stripping with a further pulsed current (for example with a duty cycle of 99%, two current strengths of between 1 mA/cm² and 16 mA/cm², and a frequency of 10⁻² Hz for about 8 minutes)

or
1. First electrochemical stripping with a pulsed current
2. First sandblasting
3. Second electrochemical stripping with a direct current (for example about 16 mA/cm² for about 8 minutes)
4. Second sandblasting

or
1. First electrochemical stripping with a pulsed current
2. First sandblasting
3. Second electrochemical stripping with a further pulsed current (for example with a duty cycle of 99%, two current strengths of between 1 mA/cm² and 16 mA/cm², and a frequency of 10⁻² Hz for about 8 minutes)

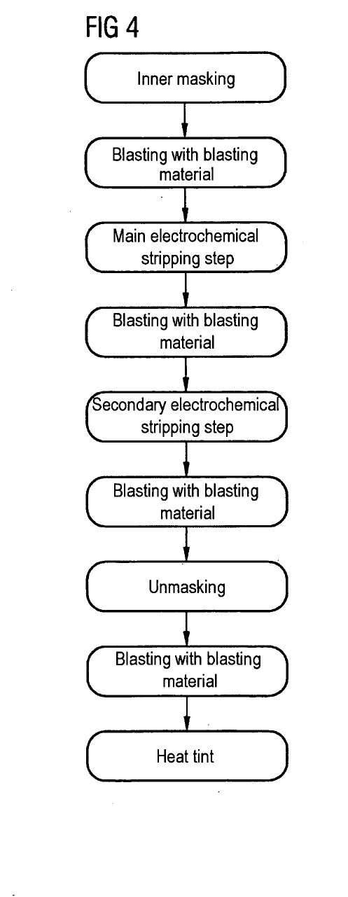

FIG. 4 illustrates a method according to the invention for removing a metal coating from a turbine blade, in the form of a flow chart.

In the method, an aluminized region lying inside the turbine blade is initially masked with wax. A cap is subsequently placed onto the blade root of the turbine blade. The turbine blade is then blasted with a blasting material in the region of the coating, in which case the blasting material may be corundum with a grain size of 46 mesh or less. The blasting pressure in this first blasting step is at most 5 bar. During the blasting, the cap protects the blade root from impact on blasting material. After the end of the first blasting step, the cap is removed again.

Before the subsequent electrochemical stripping step, outer-lying parts of the turbine blade may optionally also be masked with wax in order to protect them from undesired electrochemical attack.

In order to carry out the main electrochemical stripping step, the turbine blade in the region of the coating is immersed in an aqueous electrolyte solution which contains 6% HCl by weight. It is particularly important that the blade root does not come in contact with the electrolyte solution.

A current is subsequently passed for at most 60 minutes through the turbine blade and a secondary electrode, which is in contact with the electrolyte solution. During this process, care is taken that the temperature of the electrolyte solution lies in the range of between 15-25° C. In particular, an increase above 25° C. is prevented. Furthermore the metal ion concentration in the electrolyte solution, in particular the iron ion concentration, is monitored and the electrolyte solution is replaced in the event of too high a value, for example an Fe ion concentration of more than 100 ppm.

The current passed through the turbine blade and the secondary electrode is pulsed with a routine here, and may for example have two current strengths in the range of between 5-1000 mA/cm², a duty cycle of ≧10% and ≦90%, and a frequency of 5-1000 Hz. As an alternative, a direct current may however also be passed through the turbine blade and the secondary electrode.

After the main electrochemical stripping step has been concluded, the turbine blade is removed from the electrolyte solution and the blade root is again covered with the cap in the manner described above. A second blasting step is then carried out with corundum of grain size mesh 46 or less, the blasting pressure being at most 3 bar here and in all the further blasting steps. The cap is removed again and the masking applied externally on the turbine blade is checked and optionally replenished.

The secondary electrochemical stripping step is subsequently carried out. The procedure adopted here is similar to the main electrochemical stripping step, in this case a pulsed current which has two current densities of 5 mA/cm² and 10 mA/cm² and a duty cycle of 80% being passed through the turbine blade and the secondary electrode for at most 30 minutes. The temperature of the aqueous electrolyte solution containing HCl should not exceed 25° C., and the process time should be less than 30 minutes. A direct current may also be used instead of a pulsed current.

Now, a third blasting step is in turn carried out as after the main electrochemical stripping step. The blade root is again covered and the same blasting parameters as described above are used.

The inner masking and outer masking are then removed by burning out the wax. A further blasting step is subsequently carried out in a similar way to the third blasting step.

In order to check whether the metal coating is fully removed, the turbine blade is heat-tinted for 20-40 minutes at 500-700° C. A uniform blue coloration of the stripped surface indicates complete removal of the coating.

If residues of the coating are still found during the heat tint, these may optionally be removed by grinding.

Lastly the turbine blade may be labeled, in particular with a corresponding marking being applied for each stripping operation carried out. This ensures that the maximum permitted number of stripping operations is not exceeded.

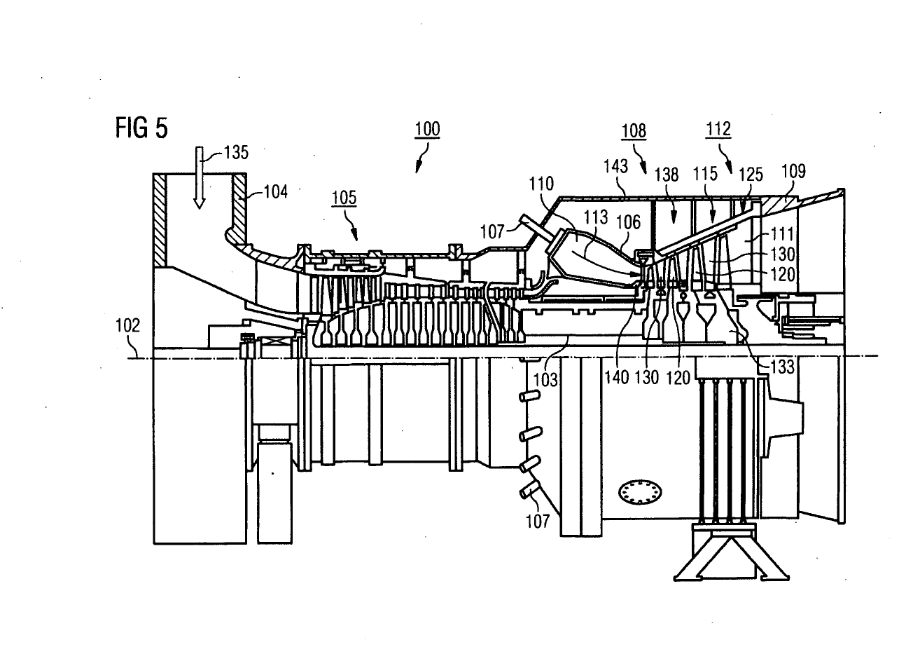

FIG. 5 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108.

Each turbine blade 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fitted on the rotor 103, for example by means of a turbine disk 133.

Coupled to the rotor 103, there is a generator or a work engine (not shown).

During operation of the gas turbine 100, air 135 is taken in and compressed by the compressor 105 through the intake manifold 104. The compressed air provided at the end of the compressor 105 on the turbine side is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant.

Substrates of the components may likewise comprise a directional structure, i.e. they are monocrystalline (SX structure) or comprise only longitudinally directed grains (DS structure).

Iron-, nickel- or cobalt-based superalloys, for example, are used as material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949 are used; with respect to the chemical composition of the alloys, these documents are part of the disclosure.

The blades 120, 130 may likewise coatings against corrosion or oxidation (MCrAlX; M is at least one element from the group iron (Fe), cobalt (Co), nickel (Ni), X is an active element and stands for yttrium (Y) and/or silicon, scandium (Sc) and/or at least one rare earth element, or hafnium). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

On the MCrAlX, there may furthermore be a thermal barrier layer, and consists for example of ZrO₂, Y₂O₃—ZrO₂, i.e. it is not stabilized or is partially or fully stabilized by yttrium oxide and/or calcium oxide and/or magnesium oxide.

Rod-shaped grains are produced in the thermal barrier layer by suitable coating methods, for example electron beam deposition (EB-PVD).

The guide vanes 130 have a guide vane root (not shown here) facing the inner housing 138 of the turbine 108, and a guide vane head lying opposite the guide vane root. The guide vane head faces the rotor 103 and is fixed on a fastening ring 140 of the stator 143.

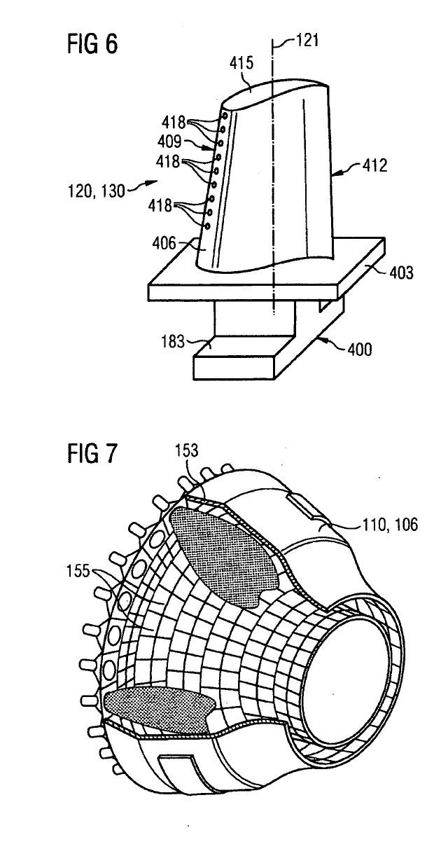

FIG. 6 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a blade surface 406 and a blade tip 415.

As a guide vane 130, the vane 130 may have a further platform (not shown) at its vane tip 415.

A blade root 183 which is used to fasten the rotor blades 120, 130 on a shaft or a disk (not shown) is formed in the fastening zone 400.

The blade root 183 is configured, for example, as a hammerhead. Other configurations as a fir tree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The blades 120, 130 may in this case be manufactured by a casting method, also by means of directional solidification, by a forging method, by a machining method or combinations thereof.

Workpieces with a monocrystalline structure or structures are used as components for machines which are exposed to heavy mechanical, thermal and/or chemical loads during operation.

Such monocrystalline workpieces are manufactured, for example, by directional solidification from the melts. These are casting methods in which the liquid metal alloy is solidified to form a monocrystalline structure, i.e. to form the monocrystalline workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or monocrystalline component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. No. 6,024,792 and EP 0 892 090 A1; with respect to the solidification method, these documents are part of the disclosure.

The blades 120, 130 may likewise have coatings against corrosion or oxidation, for example (MCrAlX; M is at least one element from the group iron (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

The density is preferably 95% of the theoretical density.

A protective aluminum oxide layer (TGO=thermal grown oxide layer) is formed on the MCrAlX layer (as an interlayer or as the outermost layer).

On the MCrAlX, there may furthermore be a thermal barrier layer, which is preferably the outermost layer and consists for example of ZrO₂, i.e. it is not stabilized or is partially or fully stabilized by yttrium oxide and/or calcium oxide and/or magnesium oxide.

The thermal barrier layer covers the entire MCrAlX layer.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance. The thermal barrier layer is thus preferably more porous than the MCrAlX layer.

Refurbishment means that components 120, 130 may need to be stripped of protective layers (for example by sandblasting) after their use. The corrosion and/or oxidation layers or products are then removed by the method described above. Optionally, cracks in the component 120, 130 are also repaired. The component 120, 130 is then recoated and the turbine blade 120, 130 is used again.

The blade 120, 130 may be designed to be hollow or solid.

If the blade 120, 130 is intended to be cooled, it will be hollow and optionally also comprise film cooling holes 418 (indicated by dashes).

FIG. 7 shows a combustion chamber 110 of a gas turbine. The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Each heat shield element 155 made of an alloy is equipped with a particularly heat-resistant protective layer (MCrAlX layer and/or ceramic coating) on the working medium side, or is made of refractory material (solid ceramic blocks).

These protective layers may be similar to the turbine blades, i.e. for example MCrAlX means: M is at least one element from the group iron (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

On the MCrAlX, there may furthermore be an e.g. ceramic thermal barrier layer which consists for example of ZrO₂, Y₂O₃—ZrO₂, i.e. it is not stabilized or is partially or fully stabilized by yttrium oxide and/or calcium oxide and/or magnesium oxide.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance.

Refurbishment means that heat shield elements 155 may need to be stripped of protective layers (for example by sandblasting) after their use. The corrosion and/or oxidation layers or products are then removed. Optionally, cracks in the heat shield element 155 are also repaired. The shield elements 155 are then recoated and the heat shield elements 155 are used again.

Owing to the high temperatures inside the combustion chamber 110, a cooling system may also be provided for the heat shield elements 155 or for their retaining elements. The heat shield elements 155 are then hollow, for example, and optionally also have film cooling holes (not shown) opening into the combustion chamber space 154.

1.-53. (canceled)

54. A method for the electrochemical removal of a metal coating from a turbine component, comprising:
immersing the component in an electrolyte solution;
placing a secondary electrode in contact with the component;
passing a current through the component,
wherein the current is pulsed and the pulse comprises:
a duty cycle from ≧10% to ≦90%,
two current densities of between 5 mA/cm2 and 1000 mA/cm2, and
a frequency of from 5 Hz to 1000 Hz.

55. The method as claimed in claim 54, wherein the current pulse comprises:
a duty cycle from ≧20% to ≦80%,
two current densities of between 10 mA/cm2 and 300 mA/cm2, and
a frequency of from 25 Hz to 300 Hz.

56. The method as claimed in claim 54, wherein
the duty cycle is 50%,
the two current densities are between 150 mA/cm2 and 200 mA/cm2, and
the frequency is 260 Hz.

57. The method as claimed in claim 54, wherein the electrolyte solution contains materials selected from the group consisting of: an inorganic acid, an organic acid, an organic base, an inorganic base and mixtures thereof.

58. The method as claimed in claim 57, wherein the electrolyte solution contains less than 6% by weight of HCl.

59. The method as claimed in claim 58, wherein the electrolyte solution contains an alkanolamine compound, or a salt containing alkanolamine, as an inhibitor.

60. The method as claimed in claim 59, wherein the electrolyte solution contains carboxylic acids and/or aldehyde compounds and/or unsaturated alcohols as further inhibitors.

61. The method as claimed in claim 60, further comprising sandblasting the component.

62. The method as claimed in claim 61, wherein a further electrochemical stripping step is additionally carried out with a further pulsed current comprising a duty cycle which is higher than the duty cycle of the first pulsed current for the first electrochemical stripping step.

63. A method for removing a metal coating from a turbine blade, comprising:
masking parts of the turbine blade;
blasting the turbine blade a first time with a blasting material in a region of the coating;
subjecting the turbine blade to a main electrochemical stripping event;
blasting the turbine blade a second time with a blasting material in a region of the coating;
subjecting the turbine blade to a second electrochemical stripping event;
blasting the turbine blade a third time with a blasting material in a region of the coating;
removing the masking material;
blasting the turbine blade a fourth time with a blasting material in a region of the coating; and
heat tinting the turbine blade to verify that the coating is completely removed from the turbine blade.

64. The method as claimed in claim 63, wherein regions lying inside the turbine blade are covered with wax.

65. The method as claimed in claim 64, wherein the blade root of the turbine blade is covered with a cap before each blasting, to protect the blade root from impact of blasting material, and the cap is removed again after the blasting event.

66. The method as claimed in claim 65, wherein corundum is used as the blasting material.

67. The method as claimed in claim 66, wherein a blasting material with a grain size of mesh 46 or less is used.

68. The method as claimed in claim 67, wherein the first blasting step is carried out with a blasting pressure of at most 5 bar and all the further blasting steps are carried out with a blasting pressure of at most 3 bar.

69. The method as claimed in claim 68, wherein outer regions of the turbine blade are covered with wax, after the first blasting step.

70. The method as claimed in claim 69, wherein the turbine blade in the region of the coating is immersed in an electrolyte solution in the main electrochemical stripping step and in the secondary electrochemical stripping step a current is passed through the turbine blade connected as an anode and a secondary electrode which is in contact with the electrolyte solution.

71. The method as claimed in claim 70, wherein HCl is the electrolyte solution.

72. The method as claimed in claim 71, wherein a concentration of HCl used is less than 20% by weight.

73. The method as claimed in claim 72, wherein the main stripping step and the secondary stripping step are performed with a temperature of the electrolyte solution between 15-25° C.
